(19) United States
(12) Patent Application Publication
(10) Pub. No.: US 2010/0026080 A1
(43) Pub. Date: Feb. 4, 2010

(54) SET OF WHEELS WITH A SYSTEM FOR ROTATION AND TRANSPOSITION OF OBSTACLES, FOR BASES OF TRAVEL BAGS, TRUNKS AND SIMILAR

(76) Inventor: Alexandre Viana COLCHIESQUI, Tatui - SP (BR)

Correspondence Address: STITES & HARBISON PLLC, 1199 NORTH FAIRFAX STREET, SUITE 900, ALEXANDRIA, VA, 22314, US

(21) Appl. No.: 12/512,379

(22) Filed: Jul. 30, 2009

(30) Foreign Application Priority Data
Jul. 30, 2008 (BR) MU 8800390-6

(51) Int. Cl. B60B 11/02

(52) U.S. Cl. 301/5.23

(57) ABSTRACT

A set of wheels with a system for rotation and transposition of obstacles, for bases of travel bags, trunks and similar, comprising a support whose nucleus has a central bore and from which terminals are projected, in the quantity of three or more, which, in their turn, also have bores on their ends where the wheels are attached; when the user pulls the baggage or the kind, the wheels of contact with the surface normally rotate on their shafts, by the terminals of their supports, on the sides of the base; when it finds an obstacle, with the stress offered, the supports begin to rotate on their shafts on the sides of the base, thus making the wheel or subsequent wheels of the wheels, rotate on the obstacle, and going over it easily and the user does not have to make bigger strength and can normally take the base with the bag or the kind.

### BACKGROUND OF THE INVENTION

As it is well known, baggage, bags, trunks and the kind many times receive heavy load and that is why it is difficult for the user to carry them. In order to make this task easier, one uses, for example, attaching small wheels on the more rigid interior facet of the baggage, which, however, due to the small diameter, require the surface, on which the baggage will be pulled, to be smooth and flat.

Other supports have been developed, such as for example, in the form of a base with wheels, from which two telescopic handles extend, forming a delicate structure and with a wheel that is not durable. These rods may bend and become damaged if the user faces some obstacle due to the stress of the baggage load or a similar object.

This is a relevant issue as, when facing obstacles, due to the weight of the baggage or similar product (which is many times heavy), the user must use much strength to make the wheel or wheels to go over it.

The present set of wheels, will enable a base to receive, on the upper surface, a recipient in the form of a baggage or the kind and even under heavy load it can be slid, thus demanding minimum strength by the user on any type of floor. The system also comprises, even facing obstacles, a set of a rotating support and wheels of the support base of the baggage or the kind that can go over this obstacle, also with minimum strength performed by the user.

### SUMMARY OF THE INVENTION

The present invention refers to a request for a patent of a utility model for a set of three or more wheels, fixed on their own shafts on the terminals of a rotating support, which is, in its turn, attached by its central shaft, to the side of a base to support trunks, bags, bags, knapsacks and other similar pieces; as per the arrangement proposed, two of those sets are attached, that is, one support on each side of the base, support their respective wheels, so that two of the wheels of each set will have contact with the surface and will rotate normally on their own shafts when the user pulls the bag or the kind. When facing obstacles, the supports rotate by the sides of the base on their own shafts, thus causing, by the wheels that are subsequent to the two wheels of support to the surface, the rotation on the obstacle found and easily going over it. Therefore, the route is made with no efforts by the user, even if an obstacle is found.

The present invention seeks to provide a set of wheels with a system for rotation and transposition of obstacles, for bases of travel bags, trunks and similar, comprising: supports of a nucleus with a central bore that can be attached to the opposed sides of the base and developed to receive the recipient, that is, for bags, trunks, knapsacks, bags and the kind, suitably attached; each support is characterized as having terminals, totaling three or more, which, in their turn, also contain bores close to their ends, by which, through rivets, the axles and the respective wheels are fixed and which rotate by means of elements, such as bearings or rollers; the referred support receives, centrally by its nucleus and also attached by a rivet, an axle that is attached to the side of the base.

### BRIEF DESCRIPTION OF THE DRAWINGS

FIG. 1 is a view in an exploded perspective of the set. In this view, one of the wheels was highlighted from the support. At the back, the base for the bags, knapsacks, trunks and the kind is shown.

FIG. 2 is a side view of the assembled set, for use, receiving a bag or the kind.

FIG. 3 is a schematic view, showing the baggage or the kind being pulled.

FIG. 4 is a schematic view, showing from the support facing an obstacle.

FIG. 5 shows the performance of the support, rotating on its shaft, so that the wheels, in rotation, will go over the obstacle.

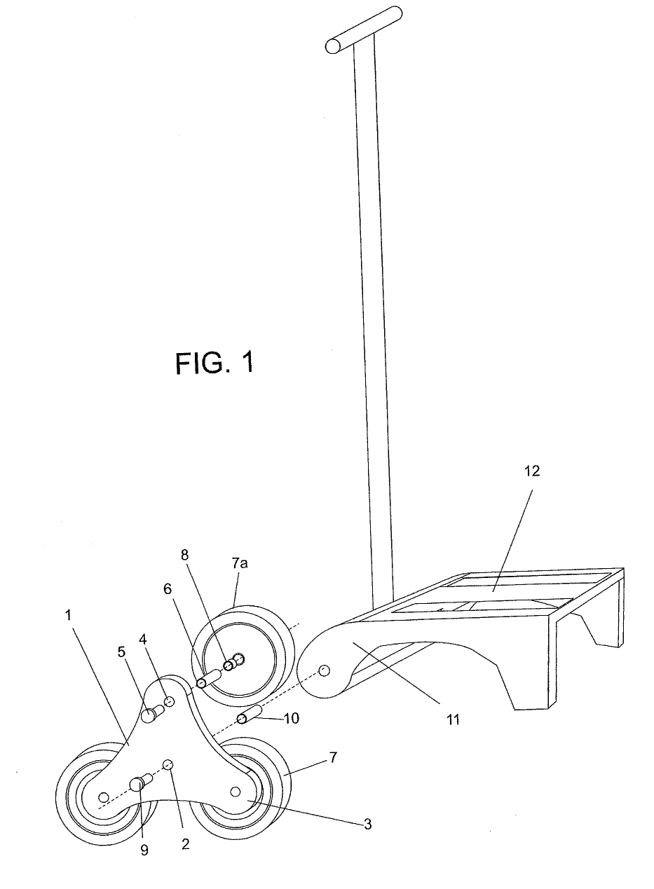

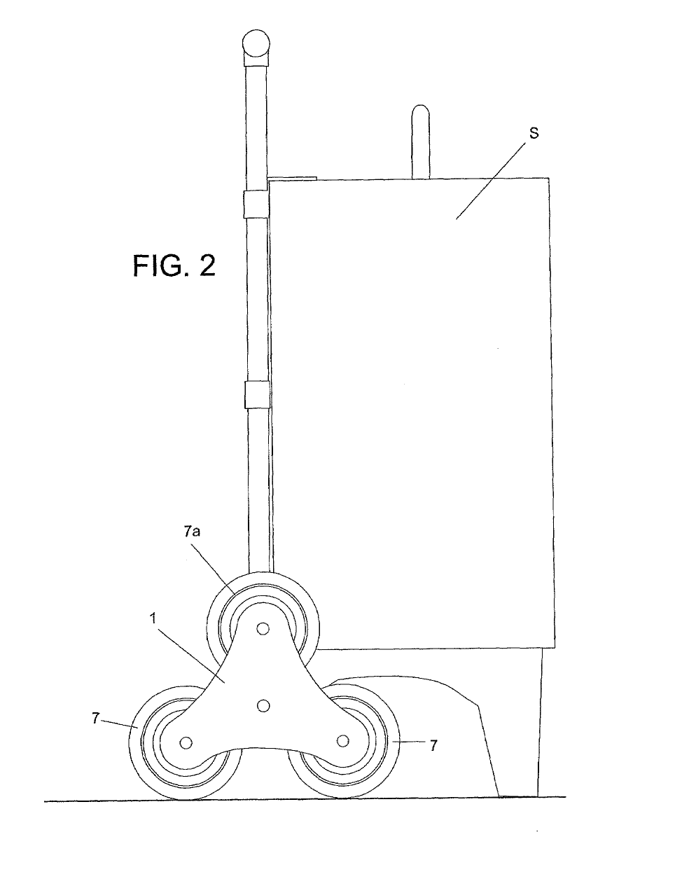

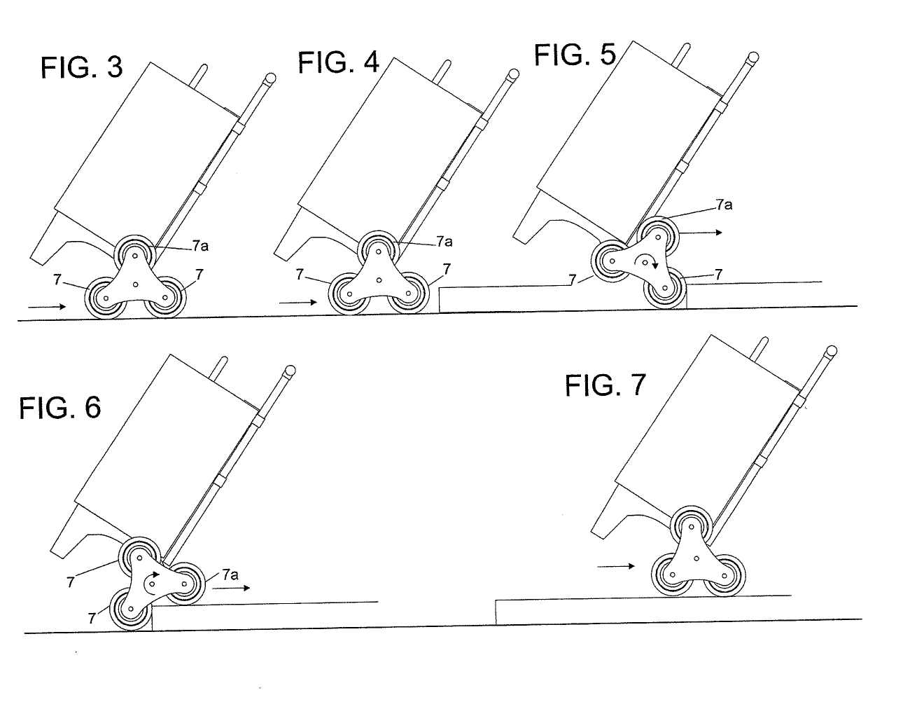

### DETAILED DESCRIPTION OF THE INVENTION

As it can be seen from the figures the set of wheels with a system for rotation and transposition of obstacles, for bases of travel bags, trunks and similar of the present invention, comprises a support (1) whose nucleus has a central bore (2) and from which terminals are projected (3), in the quantity of three or more, which, in their turn, also contain bores (4) in their ends.

Through the bores (4) of the terminals (3), by means of rivets (5), the shafts (6) of their respective wheels (7) are attached, rotating by means of bearing or roller type elements (8), or directly coupled by the nucleus to their shafts (6). The support (1), in its turn, receives, centrally by its nucleus, and also a shaft (10) fixed by a rivet (9), that is linked to the side (11) of a base (12), especially developed to receive the recipient, that is, for bags, trunks, knapsacks, bags and the kind (S), and suitably attached.

The support set (1) and its wheels (7) are fixed in pairs, that is, one in each side of (11) the base (12), so that two of the wheels (7) are supported on the surface, with the wheel or subsequent wheels (7a) being suspended. The rotational movement of each support is independent one from the other, as the obstacles may eventually reach only one support (1).

This way, when the user pulls the baggage or the kind (S), the contact wheels (7) with the surface normally rotate on their shafts (6), on the terminals of (3) their supports (1), on the sides (11) of the base (12).

When the user finds an obstacle, as it is shown in FIG. 5, with the stress offered, the supports (1) begin to rotate on their shafts (10) on the sides of (11) the base (12), making the wheels (7) and (7a) rotate on the obstacle, and then going over it easily and the user will not need to make bigger strength, and consequently he will take the base with the bag or the kind (S).

As it can be seen on FIGS. 5 and 6, after one of the wheels (7) faces an obstacle, the support rotation is forced (1), making the wheel (7a), start its rotation until it reaches the surface and then it aligns to the wheel (7) and consecutively.

The set can be used, as a unit, that is, with the support with terminals for the larger wheels, but directly applied on the lower central part of the baggage or the kind, but keeping the same principle for the system operation.

The set can also be commercialized in the form of a kit so that it can be applied in bags or the kind that do not have this type of system.

1. A set of wheels with a system for rotation and transposition of obstacles, for bases of travel bags, trunks and similar, comprising: supports of a nucleus with a central bore that can be attached to the opposite sides of the base and developed to receive the recipient, that is, for bags, trunks, knapsacks, bags and the kind, suitably attached; each support is characterized as having terminals, totaling three or more, which, in their turn, also contain bores close to their ends, by which, through rivets, the axles and the respective wheels are fixed and which rotate by means of elements, such as bearings or rollers; the referred support receives, centrally by its nucleus and also attached by a rivet, an axle that is attached to the side of the base.

2. The set of wheels with a system for rotation and transposition of obstacles, for bases of travel bags, trunks and similar, according to claim 1, wherein in an alternative constructive option, the wheels rotate in a coupled mode directly by the nucleus to their shafts.

3. The set of wheels with a system for rotation and transposition of obstacles, for bases of travel bags, trunks and similar, according to claim 1, wherein the set of supports and respective wheels are assembled in pairs on each one of the sides of the base, having independent rotational movements.

4. The set of wheels with a system for rotation and transposition of obstacles, for bases of travel bags, trunks and similar, according to claim 1, wherein in case of normal sliding on the floor, the at least two of the wheels are supported on the surface, while the wheels or the subsequent wheels are kept suspended.

5. The set of wheels with a system for rotation and transposition of obstacles, for bases of travel bags, trunks and similar, according to claim 2, wherein in case of normal sliding on the floor, the at least two of the wheels are supported on the surface, while the wheels or the subsequent wheels are kept suspended.

6. The set of wheels with a system for rotation and transposition of obstacles, for bases of travel bags, trunks and similar, according to claim 1, wherein in case of sliding on obstacles, the supports rotate jointly or independently on the shafts of the sides of the base, thus, rotating one or more wheels on the barrier/obstacle.

7. The set of wheels with a system for rotation and transposition of obstacles, for bases of travel bags, trunks and similar, according to claim 2, wherein in case of sliding on obstacles, the supports rotate jointly or independently on the shafts of the sides of the base, thus, rotating one or more wheels (7) on the barrier/obstacle.
